(19) United States
(12) Patent Application Publication
(10) Pub. No.: US 2002/0030842 A1
(43) Pub. Date: Mar. 14, 2002

(54) Printing system and method thereof

(75) Inventor: Takayuki Iida, Kanagawa (JP)

Correspondence Address: SUGHRUE, MION, ZINN, MACPEAK & SEAS, PLLC, 2100 Pennsylvania Avenue, NW, Washington, DC, 20037-3213, US

(73) Assignee: FUJI PHOTO FILM CO., LTD.

(21) Appl. No.: 09/940,528

(22) Filed: Aug. 29, 2001

(30) Foreign Application Priority Data
Aug. 29, 2000 (JP) 2000-258427

(51) Int. Cl. G06K 1/00; B41B 1/00

(52) U.S. Cl. 358/1.14; 358/1.18

(57) ABSTRACT

A system in which even when only photographic film is carried in, a photographic print of the same image quality as that of an original photographic film is obtained. In an image processing unit, due to a label of a two-dimensional bar code, which is recorded as an invisible image on a photographic print overlapping with an image, being read by the scanner and decoded, a URL which indicates a position at which image data of images on the photographic print is stored, is determined, and based on the URL, image data is read from an image server. Thereafter, the image data read from the image server is outputted to a printer processor and formed by exposure on photographic printing paper, thereby forming a photographic print. As a result, a photographic print of high quality similar to an original photographic print can be prepared.

### BACKGROUND OF THE INVENTION

1 Field of the Invention

The present invention relates to a printing system and method thereof in which an image recorded on an image recording medium is formed on another image recording medium.

2. Description of the Related Art

An exposed photographic film carried in a film processing shop or in a processing laboratory is subjected to development processing therein. At this time, when an order for making prints on the occasion of film processing or making index prints is given, photographic prints or index prints are prepared by exposing photographic printing paper on the basis of an image recorded on the photographic film, and passed to a customer together with the photographic film having been subjected to development processing.

Further, a customer makes an order for extra printing by referring to the photographic print or index print as occasion demands. When an order for extra printing is given, usually, the photographic film is carried in by a customer and printing processing is carried out by using the photographic film.

On the other hand, with diversification of image processing, a printing system has spread, wherein image data (digital image data) generated by reading an image recorded on a photographic film using a scanner or the like, is subjected to various image processing, and thereafter, the image data is used to prepare a photographic print. Due to such photographic printing system being used, it is also possible to prepare an index print in which images recorded on the photographic film are arranged in a matrix form.

Digital still cameras (DSC) and the like have been recently widespread. Film processing shops or the like may accept an order for DTP service in which a photographic print is prepared from image data of an image photographed by a digital still camera. The DTP service can be provided by using the above-described photographic printing system.

Generally, photographic prints are stored in a state of being arranged and slipped in an album or the like and photographic films are stored separately from the album (photographic prints). Further, an order for extra printing is made by referring to photographic prints arranged and slipped in the album or the like.

Accordingly, there is a possibility that, when an order for extra printing is given, photographic prints or index prints may be carried in a film processing shop or the like in place of a photographic film or an order sheet passed to a customer at the time of making prints on the occasion of film processing. In such a case, image data is prepared by reading an image of the photographic print or index print using a scanner, and photographic printing paper or the like is exposed based on the prepared image data, thereby allowing preparation of another photographic print.

However, the image quality of an original photographic print, or the resolution of a scanner has a great influence on the finish quality of an extra print. As a result, it is very difficult to prepare a photographic print of high quality.

### SUMMARY OF THE INVENTION

The present invention has been devised in view of the above-described circumstances, and an object thereof is to provide a printing system and method thereof which allows formation of an image of high quality when an order for image reproduction such as extra printing is given based on a carried photographic print or the like, in which a visible image is formed on an image recording medium such as photographic printing paper.

In order to achieve the above-described object, a first aspect of the present invention is a printing system comprising: an image server in which image data of an image formed on an image recording medium, is stored; an image reading section for reading the image formed on the image recording medium; an image information reading section for reading, from the image recording medium, image information including information for specifying the image server and a position at which the image data is stored in the image server; an image data reading section for reading the image data corresponding to the image information from the image server based on the image information read by the image information reading section; and an image reproduction section for forming, on another image recording medium which is different from the image recording medium, the image formed on the image recording medium based on one of image data, read by the image reading section, of the image or the image data read by the image data reading section.

According to the first aspect of the present invention, when the image recorded on the image recording medium is formed on another image recording medium, the image on the image recording medium is read by the image reading section and an image is formed by the image reproduction section on another image recording medium in accordance with the read image data of the image. As a result, so-called image reproduction (copy) can be performed.

At this time, in the present invention, so long as image information which specifies an image server in which image data of the image is stored, is recorded on the original recording medium with the image formed thereon, the image information is read by the image information reading section, and corresponding image data is read from the image server based on the read image information. Thereafter, based on the image data read from the image server, an image is formed on another image recording medium by the image reproduction section.

For example, when an image on an image carrier such as a negative film is formed on an image recording medium such as photographic printing paper, image data of the image is stored in the image server and image information which includes a position at which the image data is stored, is recorded on the image recording medium.

When the image on the image recording medium is formed on another image recording medium, the image information is read from the image recording medium, and based on the image information, image data is read from the image server. Based on the read image data, an image is formed on another image recording medium. As a result, an image of the same image quality as that of an image formed on the original image recording medium, can be formed on another image recording medium.

As the image carrier used at this time, a photographic photosensitive material such as negative film or positive film may also be used. Further, various storage media such as smart media in which image data prepared by photographing using a digital still camera or the like is stored, can be used.

In accordance with a second aspect of the present invention, the image information reading section is provided so as to read the image information recorded as an invisible image on the image recording medium.

According to the second aspect of the present invention, when the image information is formed as an invisible image on the image recording medium, the invisible image is read by the image information reading section. That is, the image information reading section reads image information formed as the invisible image on the image recording medium.

Due to the image information being recorded as the invisible image, even if the image information is formed on the image recording medium on the same plane as a plane on which the image is formed, an appearance of the image formed on the image recording medium is not damaged. Further, a determination as to whether the image information has been recorded cannot be made visually. Accordingly, it is possible to prevent inadvertent reading of image data from the image server.

In accordance with a third aspect of the present invention, the image information reading section is provided so as to read the image information recorded as a bar code on the image recording medium.

According to the third aspect of the present invention, the image information is displayed as a bar code and can be determined by reading the bar code. As the above-described bar code, so-called one-dimensional bar codes which have been conventionally used, may also be used. Preferably, two-dimensional bar codes may be used depending on an amount of information to be displayed or information density.

In accordance with a fourth aspect of the present invention, the image information reading section is provided in an image reading device in which the image reading section is provided.

According to the fourth aspect of the present invention, the image information reading section is provided in the image reading device such as a scanner serving as the image reading section, and a visible image formed on the image recording medium, and image information such as the invisible image can be read, as an image, by the image reading device.

In the present invention, the image reading section may also be used as the image information reading section.

Further, in the present invention, the image reading section and the image information reading section may read the image and the image data, respectively, formed on the photographic photosensitive material used as the image recording medium, and also read image information. The image reproduction section may be provided so as to form an image on the photographic photosensitive material. That is, the photographic photosensitive material such as photographic printing paper can be used as the image recording medium.

In accordance with a fifth aspect of the present invention, there is provided a printing method comprising the steps of: reading in image data recorded in an image carrier; storing the read image data in an image server; forming an image on a recording medium on the basis of the image data read from the image carrier, and recording image information including information for specifying the image server and a position at which the image data is stored in the image server on the recording medium; reading the image formed on the recording medium; reading the image information, including information for specifying the image server and the position at which the image data is stored in the image server, from the recording medium; reading in the image data corresponding to the image information from the image server on the basis of the read image information; reproducing, on another image recording medium which is different from the image recording medium, the image formed on the image recording medium on the basis of one of image data of the image read from the image reading medium or the image data read from the image server.

In accordance with a sixth aspect of the present invention according to the fifth aspect, there is provided a printing method wherein the image information is recorded as an invisible image on the image recording medium.

In accordance with a seventh aspect of the present invention according to the fifth aspect, there is provided a printing method wherein the image carrier is a photographic film, and the image recording medium is a photographic photosensitive material.

In accordance with an eighth aspect of the present invention according to the fifth aspect, there is provided a printing method wherein the image carrier is a media for recording image data of an image photographed by a digital still camera, and the image recording medium is a photographic photosensitive material.

In accordance with a ninth aspect of the present invention according to the fifth aspect, there is provided a printing method wherein the image information is recorded as a bar code on the image recording medium.

### BRIEF DESCRIPTION OF THE DRAWINGS

FIG. 1 is a schematic structural diagram of an image management network according to an embodiment of the present invention.

FIG. 2 is a schematic structural diagram of a printing processing system according to the embodiment of the present invention.

FIG. 3 is a schematic diagram showing an image processing unit and a printer processor, which are provided in the printing processing system.

FIG. 4 is a schematic structural diagram showing an example of the printer processor.

FIG. 5A is a schematic diagram showing an example of a photographic print prepared by the printing processing system; FIG. 5B is a schematic diagram showing an example of an index print prepared by the printing processing system; FIG. 5C is a schematic diagram showing an example of two-dimensional bar code printed as a label on a photographic print; and FIG. 5D is a schematic diagram showing an example of two-dimensional bar code printed as a label on an index print.

FIG. 6 is a schematic structural diagram of a principal portion of a scanner according to the embodiment of the present invention.

FIG. 7 is a flow diagram which schematically shows processing for making prints on the occasion of film processing in the printing processing system.

FIG. 8 is a flow diagram which schematically shows an example of processing for extra printing in the printing processing system.

### DESCRIPTION OF THE PREFERRED EMBODIMENTS

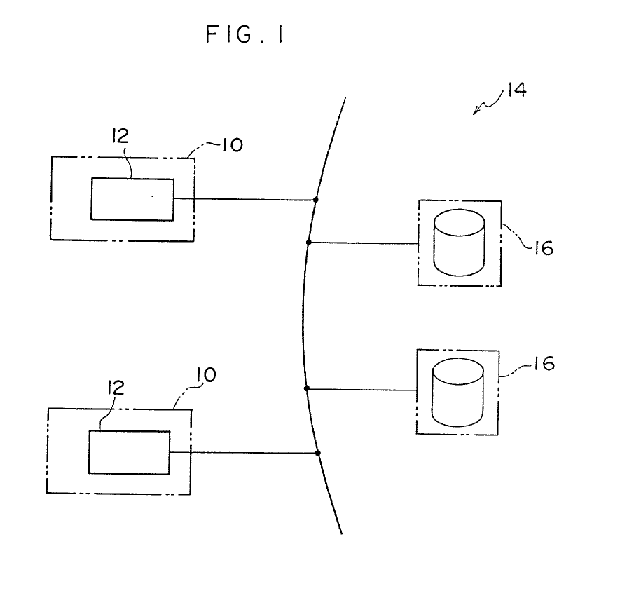

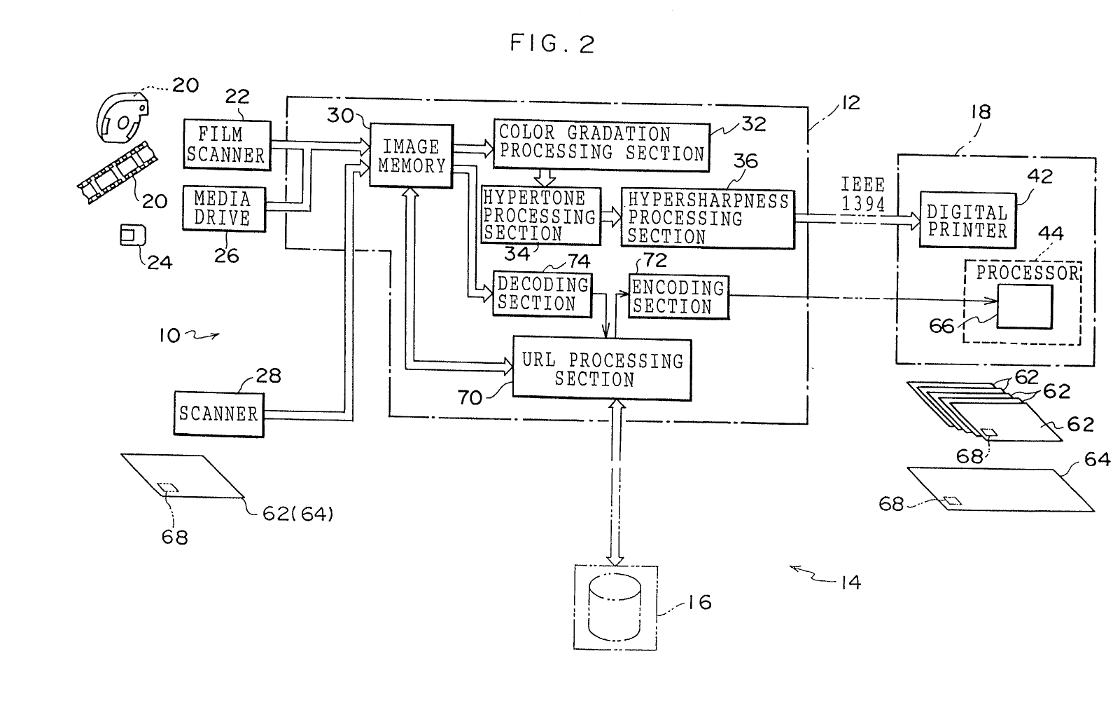

A description will be hereinafter given of an embodiment of the present invention. FIG. 2 schematically shows the structure of a printing processing system 10 according to the embodiment of the present invention. The printing processing system 10 includes an image processing unit 12. As illustrated in FIG. 1, the image processing unit 12 is connected to a wide area network (Internet) or the like. A large number of image processing units 12 are each connected to the wide area network, and a plurality of image servers 16 are connected to the wide area network, thereby forming an image management network 14. In FIG. 1, two image processing units 12 and two image servers 16 are shown as an example.

As illustrated in FIG. 2, the printing processing system 10 includes a printer processor 18 and a film scanner 22, which are each connected to the image processing unit 12.

In the printing processing system 10, when a photographic film 20 such as a negative film is used as an image carrier (medium), the photographic film 20 is loaded in the film scanner 22. The film scanner 22 reads an image recorded on the photographic film 20 and outputs the image data (digital image data) of the read image to the image processing unit 12.

As the photographic film 20 used as the image carrier, conventionally-known photographic films such as a 135-size film and an APS film can be used. A negative film and a positive film are both acceptable. The printing processing system 10 is equipped with a film processor (not shown). The photographic film 20 with an image being photographed by a camera or the like is subjected to development processing in the film processor prior to loading in the film scanner 22.

In the printing processing system 10, a media drive 26 and a scanner 28 which is a reflection type scanner such as a flat-bed scanner are provided. The media drive 26 and the scanner 28 are each connected to the image processing unit 12.

When a smart media 24 used for a digital still camera or the like, is applied to the image carrier, the smart media 24 is loaded in the media drive 26 and image data stored in the smart media 24 is read in the image processing unit 12.

That is, the printing processing system 10 can also provide a printing service of an image photographed by a digital still camera (i.e., digital printing service) in addition to a printing service of an image recorded on the photographic film 22. The image carrier is not limited to the smart media 24 and any conventionally known recording media can be used. The media drive 26 is provided so as to be adaptable for used storage media. Further, the image data recorded on the smart media 24 is not limited to image data of an image photographed by a digital still camera, and various image data such as image data obtained by editing, using a personal computer, an image photographed by a digital video camera or the like, can also be used.

The scanner 28 is provided as an image reading device. Due to an original such as a photographic print with an image formed thereon, being loaded in the scanner 28, the image of the original is read, as image data, in the image processing unit 12.

As described above, the image processing unit 12 serves as a terminal of the image management network 14 (see FIG. 1), and can also read in (down load) image data stored in the image server 16. Further, the image processing unit 12 can store, in the image server 16, image data read by the film scanner 22, media drive 26 and scanner 28.

The image processing unit 12 includes, as shown in FIG. 2, various image processing sections such as an image memory 30, a color gradation processing section 32, a hypertone processing section 34, a hypersharpness processing section 36, and the like. After image data to be inputted is stored in the image memory 30, the image processing unit 12 performs various image processing for image data by the color gradation processing section 32, hypertone processing section 34, hypersharpness processing section 36, and the like.

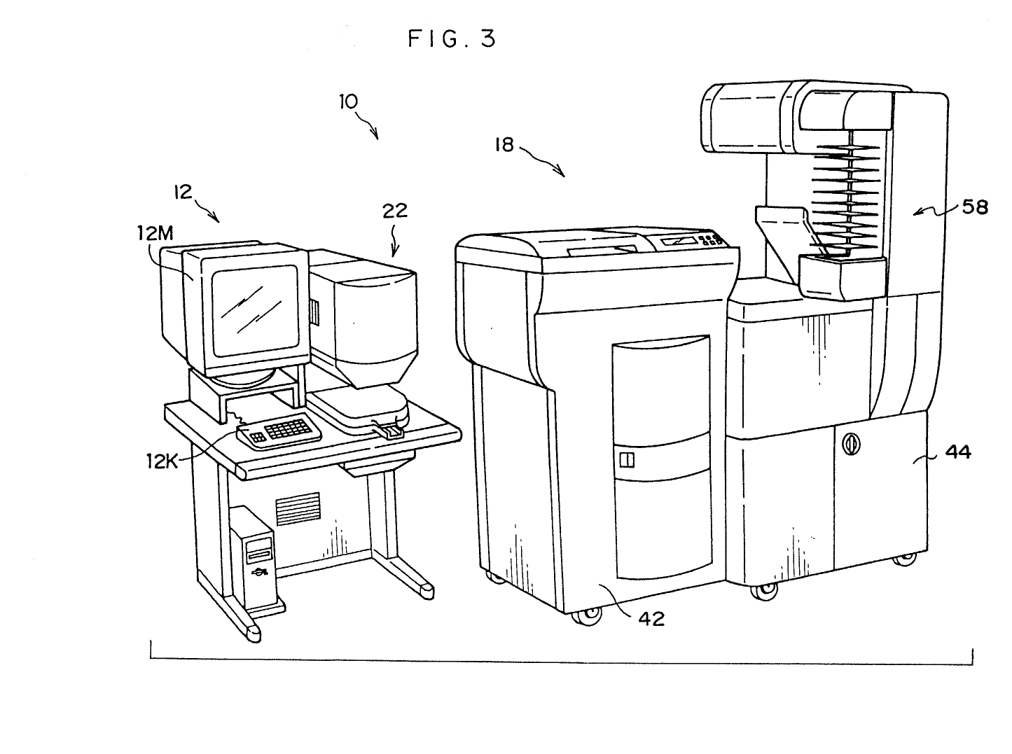

As shown in FIG. 3, the image processing unit 12 is provided with a keyboard 12K and a monitor 12M. An image corresponding to image data is displayed on the monitor 12M and various image processing can be performed while observing the image displayed on the monitor 12M.

As illustrated in FIGS. 2 and 3, the printer processor 18 is formed by a digital printer 42 and a paper processor 44 (hereinafter referred to as “processor 44”).

The image processing unit 12 is connected to the printer processor 18 at, for example, IEEE-1394 interface, and outputs image data, which has been subjected to image processing, to the printer processor 18. When the digital printer 42 of the printer processor 18 has the function of a scanner, the scanner function of the digital printer 42 may be used as a substitute for the scanner 28.

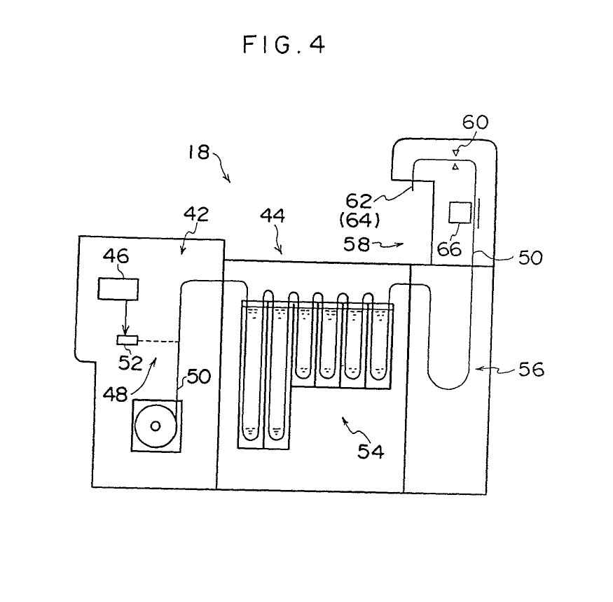

As illustrated in FIG. 4, the digital printer 42 provided in the printer processor 18 includes an image memory 46 and an exposure section 48. Image data inputted from the image processing unit 12 is temporarily stored in the image memory 46.

Photographic printing paper 50 serving as an image carrier is loaded in the exposure section 48 of the digital printer 42. When the image data is inputted, the photographic printing paper 50 in the shape of a roll is pulled out from an outer peripheral end thereof and exposed in accordance with the image data. The photographic printing paper 50 with an image formed thereon by exposure is transferred to the processor 44.

The exposure section 48 is provided with a scanning optical system (not shown) formed by, for example, laser light sources 52 of red (R), green (G), and blue (B), a polygon mirror, and an fθlens, and the like. As the exposure section 48, a general structure can be used in which main scan (the photographic printing paper 50 is irradiated with laser light of R, G, and B emitted from the laser light sources 52) is carried out while conveying the photographic printing paper 50 at a fixed speed in a sub-scanning direction, and the photographic printing paper 50 is subjected to exposure in accordance with image data.

The processor 44 has a general structure formed by a processing-solution processing section 54, a drying section 56, and a sorter section 58. In the processor 44, the photographic printing paper 50 is subjected to processing with processing solutions, such as color development, bleach-fix processing, washing and the like, and thereafter, subjected to drying processing. As a result, an image exposed on the photographic printing paper 50 is made into a visible image.

The processor 44 includes a cutter 60 in which the photographic printing paper 50 having been subjected to drying processing, is cut for each image to form photographic prints 62. The photographic prints 62 are discharged to the sorter section 58 and accumulated therein. Further, in the printer processor 18, when image data for an index print in which images of one photographic film 20 are arranged in a matrix form, is inputted from the image processing unit 12, the photographic printing paper 50 is subjected to exposure in accordance with the image data, and discharged as an index print 64 to the sorter section 58.

When images of one photographic film 20 are read in the image processing unit 12, image data based on the images is stored in the image server 16. Even in a case of the smart media 24 with image data being recorded thereon (that is, an order for digital printing service for the smart media), image data recorded on the smart media 24 or the like is read in and stored in the image server 16. An operation when the photographic film 20 is used, will be described below.

A domain name is set for each of the image servers 16. As illustrated in FIG. 2, the image processing unit 12 is provided with a URL processing section 70. In the image processing unit 12, when image data is stored, a uniform resource locator (URL) which specifies the image server 16 in which the image data is stored, and an image file in which the image data is stored or the like, is set for each image data, then the set URL is specified, and the image data is outputted.

The image server 16 specified by the URL reads in the image data, and based on the specified URL, stores therein the image data. As a result, it is possible to read image data of each image of the photographic film 20 from the image server 16 based on the URL.

The image processing unit 12 includes an encoding section 72 and a decoding section 74. In the image processing unit 12, when the URL indicating a position at which image data is stored, is set, the URL is converted by the encoding section 72 to a predetermined code and outputted to the printer processor 18.

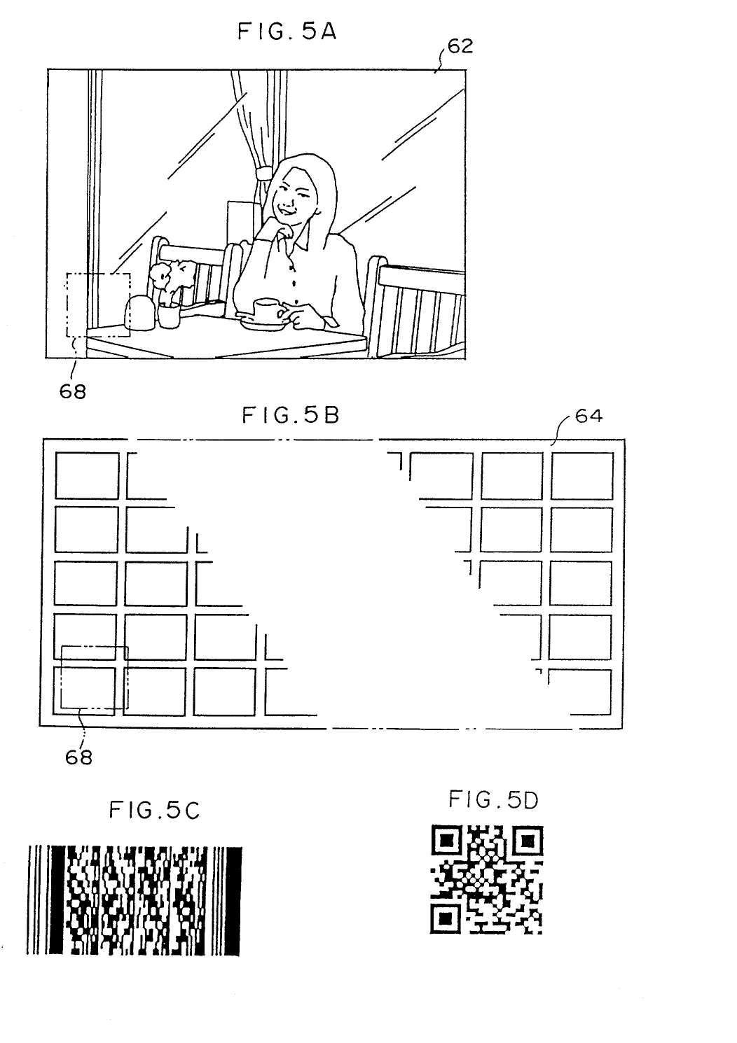

As illustrated in FIGS. 2 and 4, a label writer 66 is provided in the processor 44 of the printer processor 18. The processor 44 carries out printing, based on the code outputted from the image processing unit 12, on the photographic printing paper 50 with an image formed thereon, at a position corresponding to each image. As a result, a label 68 is formed on each of the photographic print 62 and the index print 64 as shown in FIGS. 5A and 5B.

Further, as illustrated in FIG. 2, when a symbol indicated by the label 68 is read in as image data in the image processing unit 12, the image data is decoded in the decoding section 74. As a result, a URL in which image data of an image formed on the photographic print 62 is stored, is determined.

In the printing processing system 10, a two-dimensional bar code is used as the label 68.

Generally, a bar code indicates various information by a combination of white and black parallel lines, but it displays information in one-dimensional manner. Therefore, the amount of information provided by bar codes is small and information density thereof is low.

Two-dimensional bar codes have recently been discussed in various ways in order to provide high density display of a large amount of information. In the present embodiment, a two-dimensional bar code is used, by way of example, as the label 68.

The two-dimensional bar code includes a stack type symbol in which one-dimensional bar codes are stacked as shown in FIG. 5C, and a matrix type symbol in which a checkered arrangement comprised of black and white is provided as shown in FIG. 5D. Examples of the stack type symbol include Code 49, Code 16K, Codablock, PDF 47, Super Code, Ultra Code, and the like. Examples of the matrix type symbol include Veri Code, CP Code, Data Matrix, Code 1, Maxi Code, Array Tag, Aztec Code, Data Matrix, EC200, QR Code model 2, and the like. Any of these examples of the stack type symbol and matrix type symbol may be used, and any dedicated symbol which is different from the above-described symbols may also be used.

In the above-described two-dimensional bar codes, even the Code 49 or Code 16K of the stack type symbol having the smallest amount of information can indicate (include) 49 or 77 alphanumeric characters, namely, the Code 49 or Code 16K can indicate information content which is several times of information content indicated by a conventional one-dimensional bar code. Further, the matrix type symbol can indicate (include) information of 1520 alphanumeric characters (1045 bytes) to 4296 alphanumeric characters (1847 bytes). As a result, kana characters, kanji characters (Japanese characters or Chinese characters), and binary data can be displayed in a coded form.

Further, the two-dimensional bar code can also be provided so as to have an error correction function, thereby allowing proper reading of information.

The conventional one-dimensional bar code can be read by one-dimensional scanning or by a scanner using a CCD line sensor. To the contrary, the two-dimensional bar code is read by scanning using a CCD line sensor or an area CCD sensor such that the symbol thereof is read as image data.

When the URL is set, the encoding section 72 provided in the image processing unit 12 encodes the URL to a two-dimensional bar code and outputs the same to the printer processor 18. The label writer 66 of the printer processor 18 prints the two-dimensional bar code at a predetermined position on the photographic printing paper 50. As a result, the photographic print 62 and the index print 64 are discharged with the label 68 being recorded thereon.

As illustrated in FIGS. 5A and 5B, in the printing processing system 10, the label 68 is printed on an image surface of each of the photographic print 62 and the index print 64 in a state of overlapping with an image. At this time, the label writer 66 is printed by using ink (or ribbon) which reflects only light of a predetermined wavelength in an invisible light region, for example, infrared rays.

The above-described ink (or ribbon) causes no reflection or emission of light when the ink is irradiated with visible light. When the ink is irradiated with invisible light of a predetermined wavelength, emission of light is caused by energy of the light with which the ink is irradiated. That is, the label 68 is formed as a so-called stealth (invisible) bar code printed as an invisible image.

As a result, even if the label 68 is printed overlapping with an image, there is no occurrence of deterioration in the finished quality of the photographic print 62 or index print 64, which is caused by an image formed on the photographic print 62 or index print 64 being partially covered by the label 68. Further, it is difficult to confirm visually as to whether the label 68 has been printed on the photographic print 62 or index print 64.

The printed portion of the label 68 emits light by invisible light. The printed portion which emits light, that is, a symbol on the label 68 which is provided as the two-dimensional bar code, can be read by applying light including invisible light on the label 68 and also by using a filter which removes visible light from reflected light and transmits invisible light which is emitted by irradiating the label 68 with the invisible light.

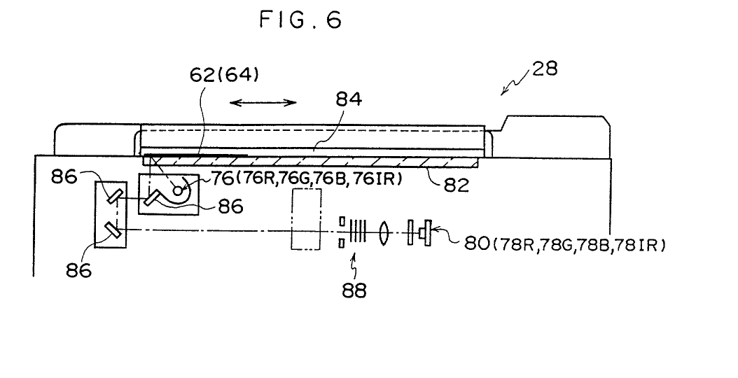

As shown in FIG. 6, the scanner 28 used by the printing processing system 10 includes light source 76 (76R, 76G, and 76B) which emits light of R, G, and B toward an original image, and a CCD line sensor 80 comprised of CCD arrays 78R, 78G, and 78B which respectively detect the light of R, G, and B reflected by the original image, and thereby forms an image reading section.

The photographic print 62 is placed on a platen glass 82 made of transparent glass with the image surface thereof facing downward, and covered by a pressing cover 84 such that the photographic print 62 is nipped between the pressing cover 84 and the platen glass 82. Further, the scanner 28 is provided with a plurality of reflecting mirrors 86 and an optical system 88 formed by various lenses and filters. When light emitted from the light source 76 toward the photographic print 62, is reflected by the photographic print 62, the reflected light is also reflected by the plurality of reflecting mirrors 86 and transmitted through the optical system 88, and thereafter made to form (focus) an image on the CCD line sensor 80. Further, due to the light source 76 and the plurality of reflecting mirrors 86 being moved relatively with respect to the photographic print 62 (i.e., sub-scanning) so that an optical path between the photographic print 62 and the CCD line sensor 80 becomes fixed, an image formed on the photographic print 62 is read in by the CCD line sensor 80.

The scanner 28 carries out A/D conversion of the image read by the CCD line sensor 80 and outputs the same as image data (digital image data). As the scanner 28, a reflection type image reading device having a general structure in which an image recorded on a reflection original is read in, can be used. Therefore, in the present embodiment, a detailed description of the scanner 28 will be omitted.

In the printing processing system 10, exposure on the photographic printing paper 50 based on image data read by the scanner 28, that is, reproduction (copy) of an image of the photographic print 62 becomes possible.

Further, the scanner 28 is also provided with a light source 76IR which emits invisible light having a predetermined wavelength (hereinafter referred to as “infrared rays” as an example) corresponding to the label 68 printed on the photographic print 62 or index print 64. Further, the CCD line sensor 80 includes a CCD array 78IR which detects light (hereinafter referred to as “infrared rays” as an example) emitted from the label 68 due to light emitted from the light source 76IR. The light source 76IR and the CCD line sensor 80 including the CCD array 78IR form an image information reading section.

As a result, when the label 68 is recorded on the photographic print 62 or index print 64, the scanner 28 reads the label 68 and outputs the same as image data to the image processing unit 12. That is, the scanner 28 is provided with the image reading section and the image information reading section in an integral manner. Further, the light source 76 and the CCD line sensor 80 serve as the image reading section and also serve as the image information reading section. In the present embodiment, there will be described a case in which the image reading section is used as the image information reading section, but the image reading section and the image information reading section may be provided separately from each other in the scanner 28, or the image information reading section may be provided independently of the scanner 28.

In the printing processing system 10, when the photographic print 62 or index print 64 is carried in and an order for preparing (making) an extra new photographic print which has an image formed on the photographic print 62 or index print 64, namely, which is a copy of the photographic print 62 or index print 64 (extra printing), is given, the image (on the photographic print 62 or index print 64) is read in by the scanner 28. At this time, when the label 68 is recorded on the photographic print 62 or index print 64, the URL is determined based on the two-dimensional bar code recorded as the label 68, the image server 16 in which image data of the image formed on the photographic print 62 is stored, is specified from the determined URL, and corresponding image data is read (down-loaded) from image server 16.

Thereafter, the image processing unit 12 of the printing processing system 10 is provided so as to prepare the photographic print 62 by effecting exposure on the photographic printing paper 50 based on image data down-loaded from the image server 16, not the image data read from the photographic print 62 loaded in the scanner 28. In the image processing unit 12, when the label 68 is not recorded on the photographic print 62 or when corresponding URL or image data does not exist, image data is read by the scanner 28 from the image formed on the photographic print 62 and exposure is effected on the photographic printing paper 50 in accordance with the read image data, thereby preparing a reproduced photographic print 62.

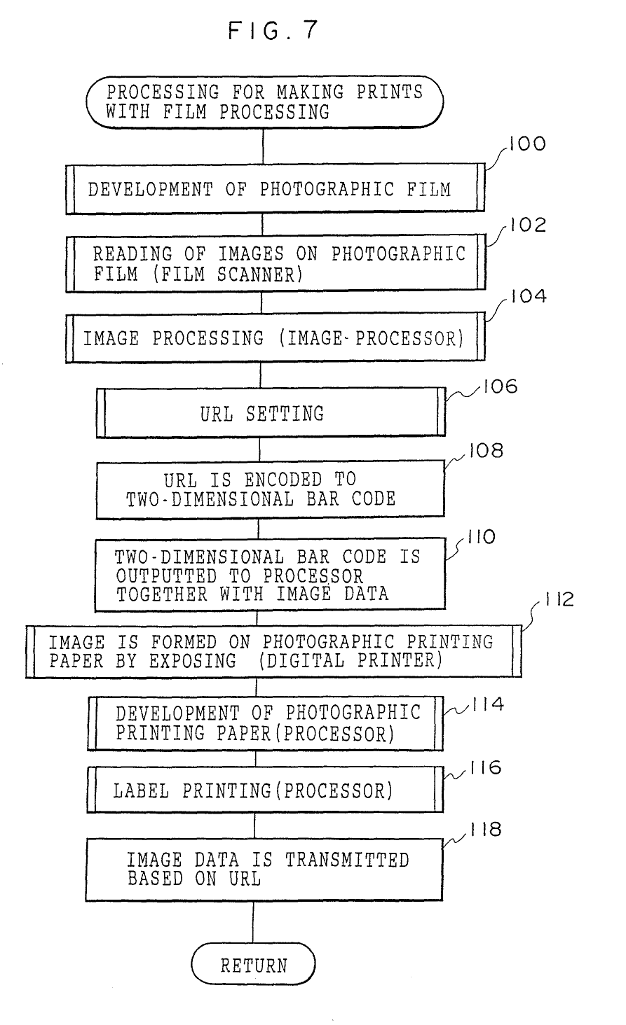

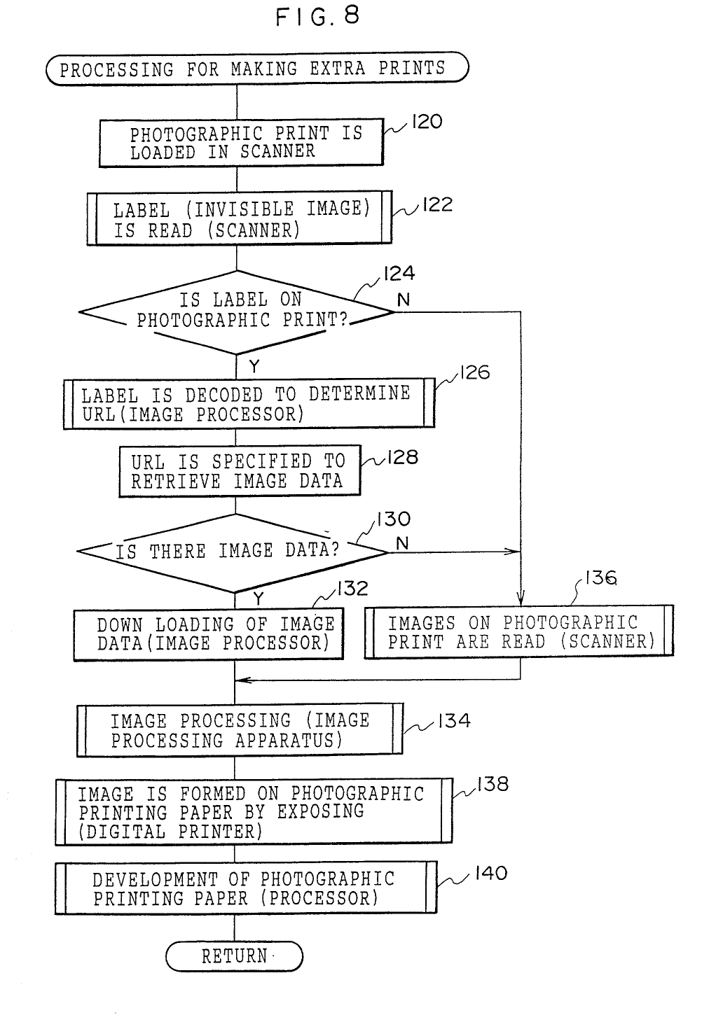

Next, operation of the present embodiment, that is, printing processing in the printing processing system 10 according to the present embodiment will be schematically described with reference to the flow charts shown in FIGS. 7 and 8.

FIG. 7 schematically shows processing for making prints on the occasion of film processing. In the printing processing system 10, when the photographic film 20 on which an image is photographed by a camera or the like, is carried in, development processing of the photographic film 20 is performed by a film processor (not shown) (step 100). Here, when an order for making prints (photographic prints 62) on the occasion of film processing, or making index prints 64 is given, in step 102, the photographic film 20 is loaded in the film scanner 22 and an image of each image frame recorded on the photographic film 20 is read in.

The image data read by the film scanner 22 is inputted to the image processing unit 12. In step 104, the image processing unit 12 reads in the image data and stores the same in the image memory 30, and various image processing such as color gradation processing, hypertone processing, and hypersharpness processing is carried out.

Further, in the image processing unit 12, concurrently with the image processing for the image data of the photographic film 20, a URL relating to storage of image data is set (step 106) and the set URL is encoded to a two-dimensional bar code (step 108).

When the image processing for image data, setting of the URL, and encoding are thus completed, the process proceeds to step 110 in which the image data and data for recording the two-dimensional bar code are outputted from the image processing unit 12 to the printer processor 18.

In the digital printer 42 of the printer processor 18, when the image data is inputted, the photographic printing paper 50 is pulled out and scan and exposure processing is performed for the photographic printing paper 50 based on the inputted image data (step 112). In the subsequent step 114, the photographic printing paper 50 on which an image is formed by scan and exposure processing, is conveyed into the processor 44, in which the photographic printing paper 50 is subjected to development processing. As a result, an image formed by exposure on the photographic printing paper 50 is made into a visible image.

The photographic printing paper 50 having been subjected to development processing, is transferred from the drying section 56 to the sorter section 58. At this time, the processor 44 operates the label writer 66 in accordance with two-dimensional bar code data inputted from the image processing unit 12 to print the label 68 such that the labels 68 respectively corresponding to images formed on the photographic printing paper 50 are each made to overlap with a corresponding image (step 116). As a result, the photographic printing paper 50 on which the labels 68 are respectively printed for images thereof, is accumulated as the photographic prints 62 in the sorter section 58.

Further, when image data in which images of one photographic film 20 are arranged in a matrix form, is inputted from the image processing unit 12 to the printer processor 18, the images are formed by exposure on the photographic printing paper 50 in a matrix form and the label 68 is printed thereon. As a result, the index print 64 with the label 68 being printed thereon is prepared. A URL indicating, for example, a file of one photographic film 20 may be used for the label 68 to be recorded on the index print 64. Further, a URL specifying image data in the file of one photographic film 20 may be used for the label 68 to be formed on the photographic print 62.

In the image processing unit 12, at a timing at which preparation of the photographic print 62 or index print 64 is completed, for example, image data and a URL which indicates a position at which the image data is stored, are transmitted (step 118).

In the image management network 14 to which the image processing unit 12 is connected, when the URL is specified and image data is transmitted, the image server 16 corresponding to the URL receives the image data and stored therein the image data based on the specified URL.

As described above, in the printing processing system 10, image data of images recorded in image frames of the photographic film 20 is stored in the image server 16. Further, the photographic film 20 having been subjected to development processing is returned to a customer together with the photographic print 62 or index print 64 with the label 68 being recorded thereon.

At this time, the label 68 is printed on the photographic print 62 or index print 64 in a state of overlapping with an image. However, the label 68 is formed as an invisible image printed by using ink or ribbon which emits light by invisible light, and therefore, there is no possibility that a finished quality of an image formed on the photographic print 62 or index print 64 be damaged by the label 68.

Further, the label 68 emits light only by specified invisible light and it is difficult to visually confirm the label 68. As a result, it is possible to prevent inadvertent reading of the label 68 printed on the photographic print 62.

Moreover, the two-dimensional bar code is used as the label 68, and high density information can be recorded. As a result, not only the URL, but also, exposure conditions under which an image of image data is formed by exposure on the photographic printing paper 50, processing conditions under which image processing is carried out in the image processing unit 12, and the like can be recorded together. The exposure conditions or processing conditions for image data may also be stored in the image server 16 together with image data.

In the printing processing system 10, when the smart media 24 with image data recorded thereon is carried in and an order for digital print service is given, the smart media 24 is loaded in the media drive 26 and the image data recorded on the smart media 24 is read in the image processing unit 12.

When the image data recorded in the smart media 24 is read in the image processing unit 12, the image processing unit 12 performs predetermined image processing for the image data and outputs the image data subjected to the predetermined image processing to the printer processor 18 to prepare the photographic print 62 or index print 64 based on the image data recorded on the smart media 24.

Further, in the image processing unit 12, the URL is set in the same manner as in reading of images on the photographic film 20, and the image data recorded on the smart media 24 is transmitted to the image server 16, and based on the specified URL, the image data is stored in the image server 16.

In general, when an order for making extra prints is given (accepted), the extra prints are made based on the photographic film 20, carried in by a customer, having been subjected to development processing. However, the photographic print 62 or index print 64 prepared at the time of making prints on the occasion of film processing, not the photographic film 20, may be carried in a processing laboratory or the like. FIG. 8 schematically shows processing when an order for making extra prints from the photographic print 62 or index print 64 carried in by the customer, is given.

In the printing processing system 10, when an order for making extra prints from the photographic film 20 carried in by the customer, is given, the photographic film 20 is loaded in the film scanner 22 and images recorded on the photographic film 20 are read in the same manner as in the processing for making prints on the occasion of film processing. Exposure is carried out for the photographic printing paper 50 based on image data of the read images, and the photographic print 62 of an image ordered for making extra prints, is prepared.

As shown in FIG. 8, when the photographic print 62 is carried in and an order for making extra prints therefor is given, first, in step 120, the photographic print 62 is loaded in the scanner 28 and image reading from the photographic print 62 is performed by using the light source 76IR of invisible light and the CCD array 78IR of the CCD line sensor 80, provided in the scanner 28. As a result, the label 68 printed as an invisible image on the photographic print 62, is read in.

At this time, the label 68 is printed on the surface of the photographic print 62 at which an image is formed, in such a manner as to overlap with the image. Therefore, when the label 68 is read, the photographic print 62 can be loaded in the scanner 28 without taking the label 68 printed on the photographic print 62 into consideration. That is, because the label 68 is made to overlap with the image, the label 68 can be reliably read in by merely loading the photographic print 62 in the scanner 28 so as to read the image on the photographic print 62.

In step 122, image data of an invisible image read by the scanner 28 is read in the image processing unit 12. In the subsequent step 124, it is determined by the image processing unit 12 as to whether the label 68 of an invisible image is printed on the photographic print 62 based on image data of the invisible image.

When a determination is made that the label 68 has been printed (when the decision of step 124 is affirmative), the process proceeds to step 126 in which the image data of the invisible image is read in the decoding section 74 and the two-dimensional bar code printed as the label 68 is decoded in the decoding section 74. In the URL processing section 70, a URL which indicates a position at which image data of an image recorded on the photographic print 62 is stored, is determined from the decoded data.

Subsequently, in step 128, the determined URL is retrieved and it is determined as to whether there is the determined URL and whether image data is stored in the determined URL. So long as image data is stored in the determined URL, the decision of step 130 is affirmative. The process proceeds to step 132 in which image data indicated by the determined URL is down loaded.

When, in the image processing unit 12, predetermined image processing is thus carried out for the down-loaded image data (step 134), the image data is outputted to the printer processor 18. If the label 68 is not printed on the photographic print 62 loaded in the scanner 28 (when the decision of step 124 is negative) or if the determined URL does not exist or corresponding image data has been deleted for the purpose of maintaining a space in which new image data is stored because corresponding image data was stored in the image server 16 for a long period of time (when the decision of step 130 is negative), the process proceeds to step 136 in which an image on the photographic print 62 loaded in the scanner 28 is read. In step 134, predetermined image processing is performed for image data of the read image.

The digital printer 42 of the printer processor 18 carries out exposure on the photographic printing paper 50 based on image data inputted from the image processing unit 12 (step 138). Further, processor 44 carries out development processing for the photographic printing paper 50 with an image being formed thereon by exposure (step 140).

As described above, in the printing processing system 10, when image data of an image for which an order for making extra prints is given, is stored in the image server 16, photographic prints are prepared by using the stored image data. Therefore, high quality photographic prints, whose quality is the same as that of the photographic print made in the processing for making prints on the occasion of film processing, can be prepared. Further, these high quality photographic prints can be simply prepared by merely loading the photographic print 62 carried in on the scanner 28.

As the film scanner 22 for reading images recorded on the photographic film 20, a scanner of high resolution is generally used. Due to exposure being carried out for the photographic printing paper 50 based on image data read by the film scanner 22, the photographic print 62 of high quality can be obtained.

On the other hand, the scanner 28 for reading an image recorded on the photographic print 62 has a resolution sufficient to read a two-dimensional bar code such as the label 68 or a symbol printed as a bar code. However, the scanner 28 is a scanner for reading an image, which is larger than an image recorded on the photographic film 20, and therefore, the resolution of the scanner 28 is lower than that of the film scanner 22.

Accordingly, when exposure is carried out for the photographic printing paper 50 based on image data read by the scanner 28, the finished quality of a photographic print may be deteriorated (for example, an image may become coarse) as compared with a case in which exposure is carried out for the photographic printing paper 50 based on image data read by the film scanner 22. Particularly, when a small image formed on the index print 64 is read by the scanner 28 and exposure is performed on the photographic printing paper 50, the finished quality of a photographic print is inevitably deteriorated (for example, a finished photographic print may have a coarse-grained image).

At this time, in the printing processing system 10, exposure is carried out for the photographic printing paper 50 based on the image data stored in the server 16, namely, read from the photographic film 22 by the film scanner 22. Therefore, a high-quality photographic print similar to a photographic print prepared from the photographic film 22 can be obtained without using the photographic film 22.

Although not shown in the flow chart of FIG. 8, the label 68 showing a URL which indicates the position at which image data is stored, may be printed on a photographic print prepared when an order for making extra prints is given, in the same manner as in the photographic print 62 prepared by making prints on the occasion of film processing. In this case, it is preferable to designate (print) that the photographic print is that prepared when an order for making extra prints is given, and is different from an original photographic print 62 prepared at the time of making prints on the occasion of film processing.

When the label 68 is not printed on the photographic print prepared by making extra prints, or when the label 68 which clearly indicates a photographic print prepared by making extra prints, is printed, inadvertent reading of image data stored in the image server 16 can be prevented. This is preferable from the standpoint of protecting image data.

A method may be considered, wherein a code showing a URL which indicates the position at which image data is stored, is recorded on an order sheet, not on the photographic print 62 or index print 64, and the order sheet is passed to a customer together with the photographic film 20 having been subjected to development processing. However, it may be supposed that the order sheet is also stored separately from the photographic print 62 or index print 64 in the same manner as in the photographic film 20. Accordingly, there is a possibility that when an order for making extra prints is made by referring to the photographic print 62 or index print 64, the order sheet is not found, thereby resulting in that storage of image data in the image server 16 may become meaningless.

To the contrary, due to the label 68 being printed on the photographic print 64 or index print 64, image data stored in the image server 16 can be reliably read. As a result, a photographic print of high quality can be prepared at the time of making extra prints, without the photographic film 20.

That is, even in the case of print-to-print (PTP) service for preparing a new photographic print from the photographic print 62 or index print 64, a photographic print of the same quality as that of a photographic print prepared at the time of making prints on the occasion of film processing, can be obtained.

In the present embodiment, there was described a case in which image data of an image recorded on an image recording medium such as the photographic film 20 is stored in the image server 16. However, not only image data, but also exposure conditions or the like set based on each image data may also be stored together with the image data. As a result, a print of the same quality as that of the photographic print 62 can be prepared.

In the present embodiment described above, the image server 16 is provided separately from the image processing unit 12. However, when storage means such as a hard disk drive (HDD) in which image data is stored, is provided in the image processing unit 12, the storage means may be used as the image server 16.

Further, in the present embodiment, the image management network 14 is formed by using a wide area network. More preferably, the image data stored in the image server 16 is prevented from being inadvertently read out due to, for example, the printing processing system 10 (image processing unit 12) and the image server 16 being connected by a dedicated communication line.

In the present embodiment, the two-dimensional bar code is used as the label 68. However, so long as the amount of information to be recorded can be displayed by a one-dimensional bar code, the one-dimensional bar code may also be used. Further, the label 68 is not limited to the two-dimensional bar code, and may also be formed by using character information or various codes. Alternatively, when exposure conditions or image processing conditions are recorded, a URL may be included in such information by using an electronic visual system.

Further, in the present embodiment, an invisible image is used as the label 68, but the label 68 may also be formed by a visible image. In this case, it suffices that the image may be printed on the reverse side of the photographic printing paper 50 or in a non-image region (for example, a blank space in the periphery of the image).

Moreover, the present embodiment was described with the printing processing system 10 including the film processor, film scanner, media drive 26, and the like, being taken as an example. However, any structure may also be used in which the scanner 28, image processing unit 12, and printer processor 18 are provided and the image processing unit 12 is connected to the image server 16 to form a network.

Still further, in the present embodiment, the photographic printing paper 50 is used as the image recording medium. However, the image recording medium is not limited to the same, and various recording materials, such as recording paper, on which a visible image is formed, can be used. That is, the image reproduction means is not limited to the printer processor 18 which forms an image on a photosensitive material such as the photographic printing paper 50, and various image forming apparatuses by which visible images are formed on the recording materials based on image data, can be applied.

As described above, in the present invention, when image information which specifies an image server with image data of an image formed on the image recording medium being stored therein, is recorded on the image recording medium, an image is formed on another image recording medium by reading the image data from the image server based on the image information. Accordingly, the present invention has an excellent effect in that an image of the same quality as that of an image formed on an original image recording medium, can be formed on another image recording medium.

Further, because of the image information being recorded as an invisible image, the image information can be recorded overlapping with an image formed on the image recording medium. Moreover, a large amount of information can be recorded by using the two-dimensional bar code for recording the image information.

What is claimed is:

1. A printing system comprising:
an image server in which image data of an image formed on an image recording medium, is stored;
an image reading section for reading the image formed on the image recording medium;
an image information reading section for reading, from the image recording medium, image information including information for specifying the image server and a position at which the image data is stored in the image server;
an image data reading section for reading the image data corresponding to the image information from the image server based on the image information read by the image information reading section; and
an image reproduction section for forming, on another image recording medium which is different from the image recording medium, the image formed on the image recording medium based on one of image data, read by the image reading section, of the image or the image data read by the image data reading section.

2. A printing system according to claim 1, wherein the image information reading section is provided so as to read the image information recorded as an invisible image on the image recording medium.

3. A printing system according to claim 1, wherein the image information reading section is provided so as to read the image information recorded as a bar code on the image recording medium.

4. A printing system according to claim 2, wherein the image information reading section is provided so as to read the image information recorded as a bar code on the image recording medium.

5. A printing system according to claim 1, wherein the image information reading section is provided in an image reading device in which the image reading section is provided.

6. A printing system according to claim 2, wherein the image information reading section is provided in an image reading device in which the image reading section is provided.

7. A printing system according to claim 1, wherein the image reading section is used as the image information reading section.

8. A printing system according to claim 2, wherein the image reading section is used as the image information reading section.

9. A printing system according to claim 1, wherein the image reading section and the image information reading section are provided so as to read the image and the image data, respectively, formed on a photographic photosensitive material used as the image recording medium, and an image is formed on a photographic photosensitive material by the image reproduction section.

10. A printing system according to claim 2, wherein the image reading section and the image information reading section are provided so as to read the image and the image data, respectively, formed on a photographic photosensitive material used as the image recording medium, and an image is formed on a photographic photosensitive material by the image reproduction section.

11. A printing method comprising the steps of:
reading in image data recorded in an image carrier;
storing the read image data in an image server;
forming an image on a recording medium on the basis of the image data read from the image carrier, and recording image information including information for specifying the image server and a position at which the image data is stored in the image server on the recording medium;
reading the image formed on the recording medium;
reading the image information, including information for specifying the image server and the position at which the image data is stored in the image server, from the recording medium;
reading in the image data corresponding to the image information from the image server on the basis of the read image information;
reproducing, on another image recording medium which is different from the image recording medium, the image formed on the image recording medium on the basis of one of image data of the image read from the image reading medium or the image data read from the image server.

12. A printing method according to claim 11, wherein the image information is recorded as an invisible image on the image recording medium.

13. A printing method according to claim 11, wherein the image carrier is a photographic film, and the image recording medium is a photographic photosensitive material.

14. A printing method according to claim 11, wherein the image carrier is a media for recording image data of an image photographed by a digital still camera, and the image recording medium is a photographic photosensitive material.

15. A printing method according to claim 11, wherein the image information is recorded as a bar code on the image recording medium
